(19) United States
(12) Patent Application Publication
(10) Pub. No.: US 2015/0228002 A1
(43) Pub. Date: Aug. 13, 2015

(54) APPARATUS AND METHOD FOR ONLINE SEARCH, IMAGING, MODELING, AND FULFILLMENT FOR INTERIOR DESIGN APPLICATIONS

(71) Applicant: Kelly Berger, Los Altos, CA (US)

(72) Inventor: Kelly Berger, Los Altos, CA (US)

(21) Appl. No.: 14/617,250

(22) Filed: Feb. 9, 2015

Related U.S. Application Data
(60) Provisional application No. 61/937,829, filed on Feb. 10, 2014.

(51) Int. Cl. G06Q 30/06; G06F 17/30

(52) U.S. Cl. CPC G06Q 30/0627; G06F 17/30864; G06F 17/30899

(57) ABSTRACT

A system and method are described for searching and providing a ranked list of home products comparable/compatible with an existing product. For example, one embodiment of a method comprises: collecting attributes related to home products in a products database, each of the attributes having a weight associated therewith; receiving user input in the form of an existing product; determining input attributes for the existing product; comparing the input attributes with the attributes related to the home products in the products database and responsively determining distances between the input attributes and the attributes related to the home products in the products database; and generating a ranked list of home products from the products database using the determined distances and the weights associated with each of the attributes.

### RELATED APPLICATIONS

This application claims the benefit of and priority to co-pending U.S. Provisional Patent Application No. 61/937,829, filed, Feb. 10, 2014, entitled, “Apparatus And Method For Online Search, Imaging, Modeling, And Fulfillment For Interior Design Applications,” which is hereby incorporated by reference.

### BACKGROUND

Comfortable and functional home furnishings and decorations have served the basic human need for shelter for many centuries. Design and manufacturing techniques have evolved over the years, and the functional needs are fulfilled by many products in the marketplace. Consumers now want to create an overall look in their living spaces that reflects their personality, but they have to assemble the look with many products purchased from several different merchants. Many consumers lack the design capabilities to complete this task so they often give up and settle for what they can easily find.

This document describes an interior design software platform that solves this design problem to allow anyone to purchase a set of interior design products to create the desired look for their living space. It uses detailed product attributes and design heuristics to rank products that go well together, a color library system to allow designers to review designs in various colors, a merchandising system to allow store owners to manage sets of products for shopping, imaging technology to allow users to visualize the products, 3D modeling technology to allow users to view the products in their room, and an on-demand fulfillment system to efficiently manufacture and deliver the set of products to the customer.

The future potential for the platform is to reinvent how interior design products are designed, purchased, and manufactured. The home furnishings industry can migrate from mass production of a limited selection of products to just-in-time manufacturing of a much wider selection of items that are customized into unique looks by each customer. Consumers will have access to more products and designers will be able to offer more products because the development costs are much lower.

Interior design is different from most other product categories in that it consists of a wide variety of decorative elements that are layered one on top of the other. Every item that you place in a living space relates to and affects all the other items within view. Most people want to create a look for their living space that reflects their personality and is appealing to the eye, and this look is made up of many interior design products.

The way companies sell home furnishings and decorations today is by organizing products into categories such as furniture and bedding. Consumers purchase individual items and have to determine how to combine a set of items to create an arrangement that is both functional and attractive, often buying items from many different merchants. But this requires an understanding of color science and design heuristics beyond the capabilities of many people. They often seek out assistance from a professional interior designer or settle for a look that is not appealing.

This problem has not been solved to date because it is far too costly to inventory all the available design styles and color schemes and organize them into every possible combination within a catalog or brick-and-mortar store. The limited solution to date consists of merchants offering a small selection of items that are designed to look good together and then refreshing the selection periodically.

### BRIEF DESCRIPTION OF THE DRAWINGS

A better understanding of the present invention can be obtained from the following detailed description in conjunction with the following drawings, in which:

FIG. 1 illustrates one embodiment of a system for an interior design platform;

FIGS. 2-6 illustrate a plurality of graphical user interface features employed in one embodiment of the invention;

FIG. 7 illustrates additional details of one embodiment of an interior design platform;

FIG. 8 illustrates a portion of an interior design platform which includes an ordering module and a fulfillment module;

FIG. 9 illustrates an exemplary design kit in accordance with one embodiment of the invention;

FIG. 10 illustrates a method for performing a search in accordance with one embodiment of the invention;

FIG. 11 illustrates one embodiment of a method for colorway generation; and

FIGS. 12-24 illustrate different graphical user interface features employed in one embodiment of the invention.

### DETAILED DESCRIPTION

The elements of interior design are based on known science and design heuristics that can be implemented in a system. The Interior Design Platform described herein is the first end-to-end system solution that integrates several technologies to provide a complete mass customization platform for home décor and furnishings products. One embodiment of the invention works by assigning design attribute data to interior design products and applying design heuristics to rank each product against every other product or set of products to enable the user to create an appealing look. In one embodiment, a set of tools are provided to allow textile designers to upload design artwork files for fabrics, and a color library system is included to create the new design in many different colorways. Merchandising tools included in one embodiment allow store owners to manage curated sets of products for efficient shopping. One embodiment of the invention also includes imaging and 3D modeling technologies to visualize how any set of products will look together and how they will look in any living space. Lastly, the fulfillment system automates the process of customizing the design artwork files to the colors ordered by the customer, selects the fulfillment sites for the optimum cost and delivery time, and manages the just-in-time inventory of supplies for the manufacturing process. Many applications will be built on this platform to provide this solution in any shopping environment and allow anyone to create a unique look with a set of coordinated products that look good together.

System Components

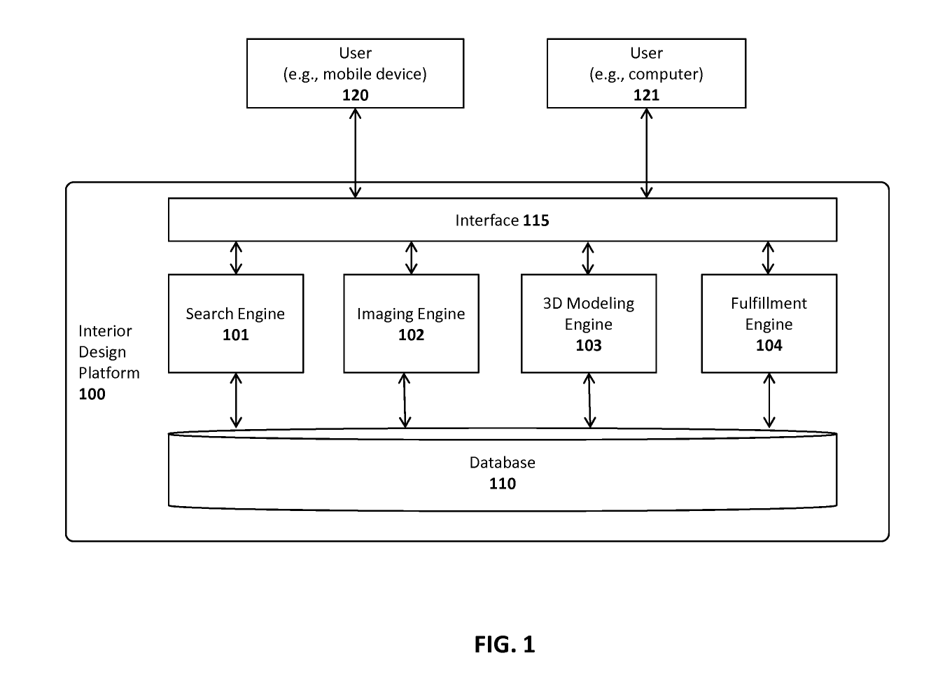

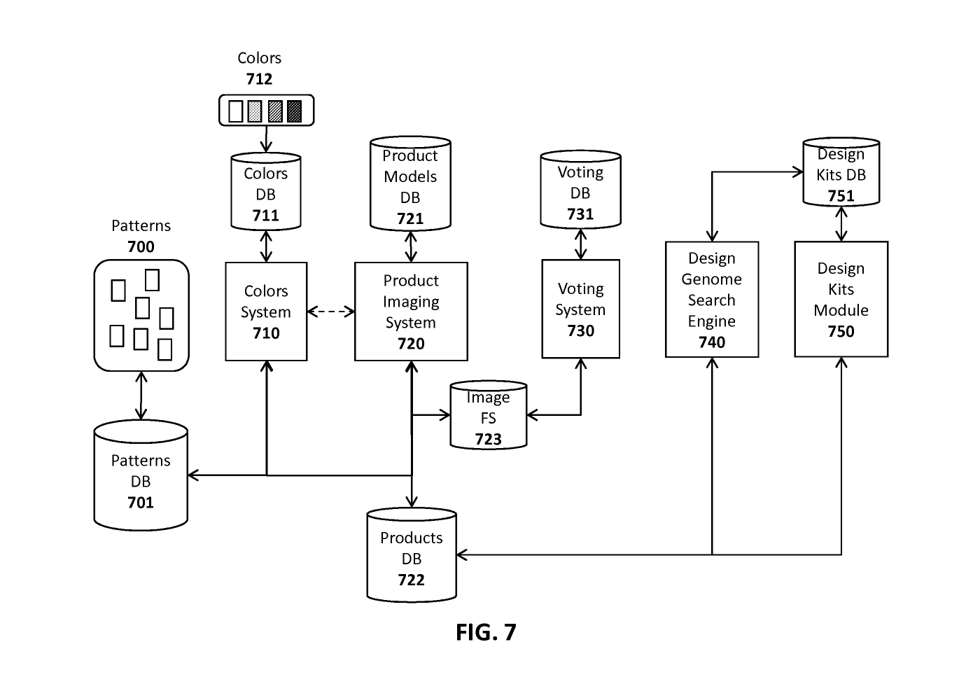

FIG. 1 illustrates one embodiment of a high level system architecture for an interior design platform 100 operated as a service over a network (e.g., the Internet). Additional embodiments of a system architecture are described below with respect to FIGS. 7-9. Users connect to the interior design platform 100 from various types of computing devices including, for example, mobile devices 120 (e.g., tablets, smartphones, etc) and computers (e.g., PCs, Macs, etc). In one embodiment, an interface 115 is exposed allowing the different types of devices to access the services provided by the interior design platform 100. For example, the interface may comprise an application programming interface (API) 115 such as a Web services interface and may be built according to various different types of inter-process network communication protocols such as representational state transfer (REST) and Simple Object Access Protocol (SOAP).

In the illustrated embodiment, the Interior Design Platform 100 includes a design-driven search engine 101 that indexes all of the available products based on potentially hundreds of attributes such as design style, colors, patterns, design scale, design technique, materials, form, visual weight, craftsmanship, finish & trim, fabric content, and metal content, to name a few. In addition, as discussed below with respect to FIG. 7, the design-driven search engine may also perform searches in accordance with a patterns database 701, a colors system 710 which maps color ways to patterns, results generated by a voting system 730 and design kits generated via a design kits module 750. Details of each of these components are set forth below. The embodiment shown in FIG. 1 also includes an imaging engine 102 to visualize products, a 3D room modeling engine 103 to visualize products in the user's home, and a fulfillment engine 104 to efficiently manufacture items from all of the available materials. All of the system components may be provided with access to a database 110 (or a plurality of databases) for storing and retrieving data required to perform the operations described herein.

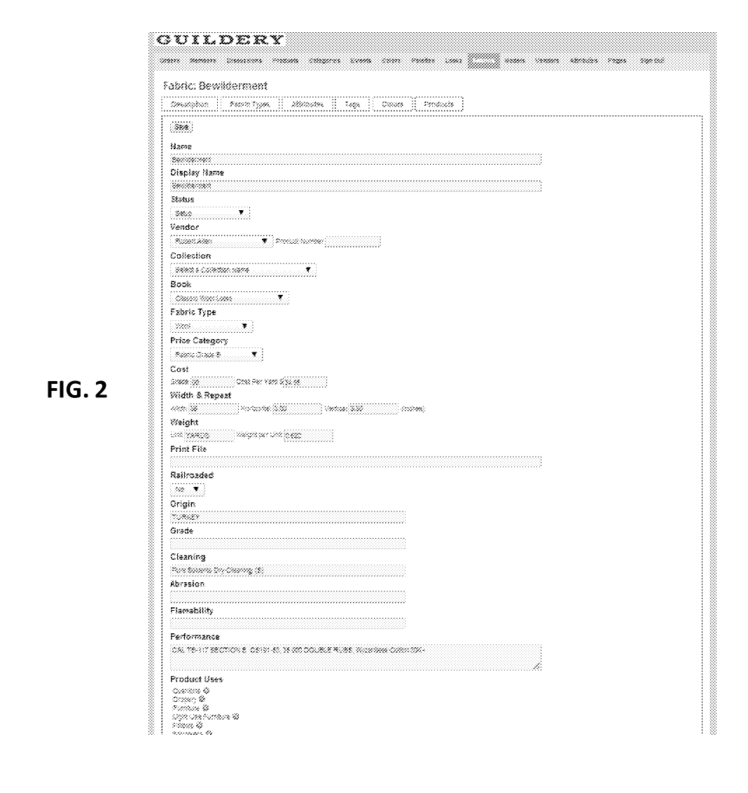

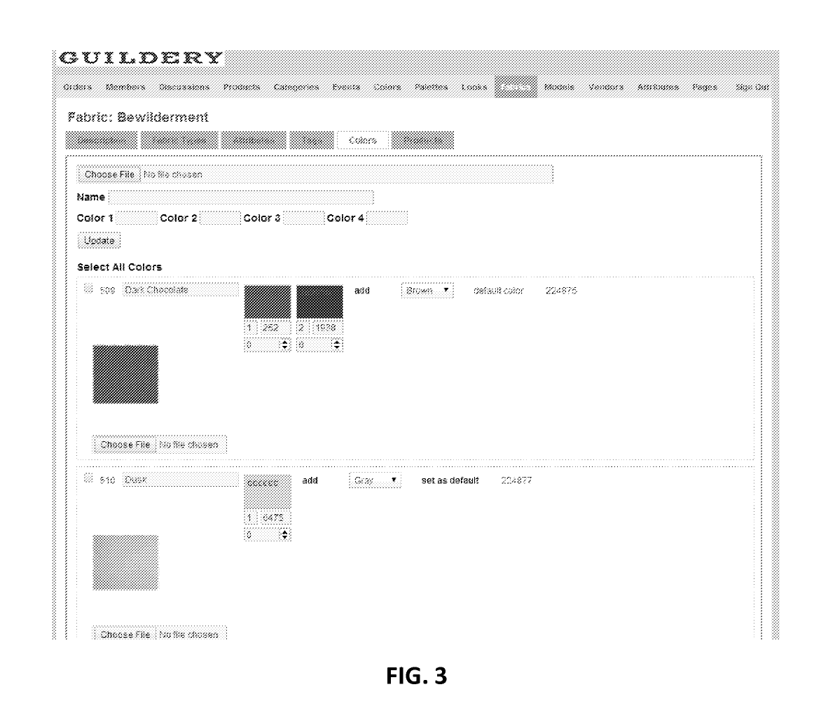

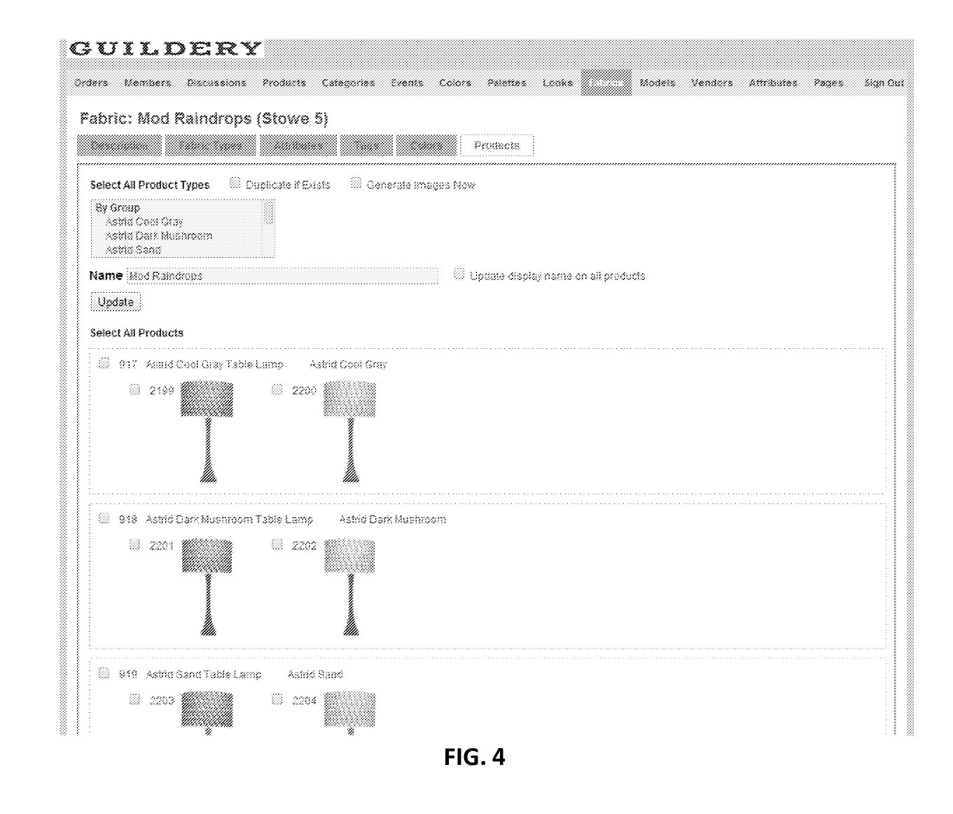

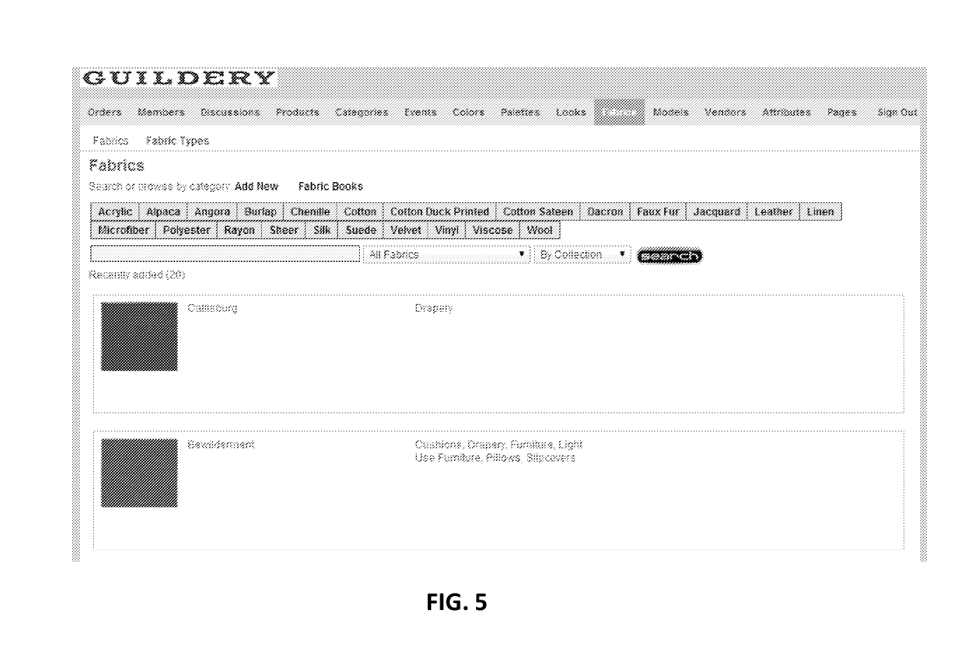

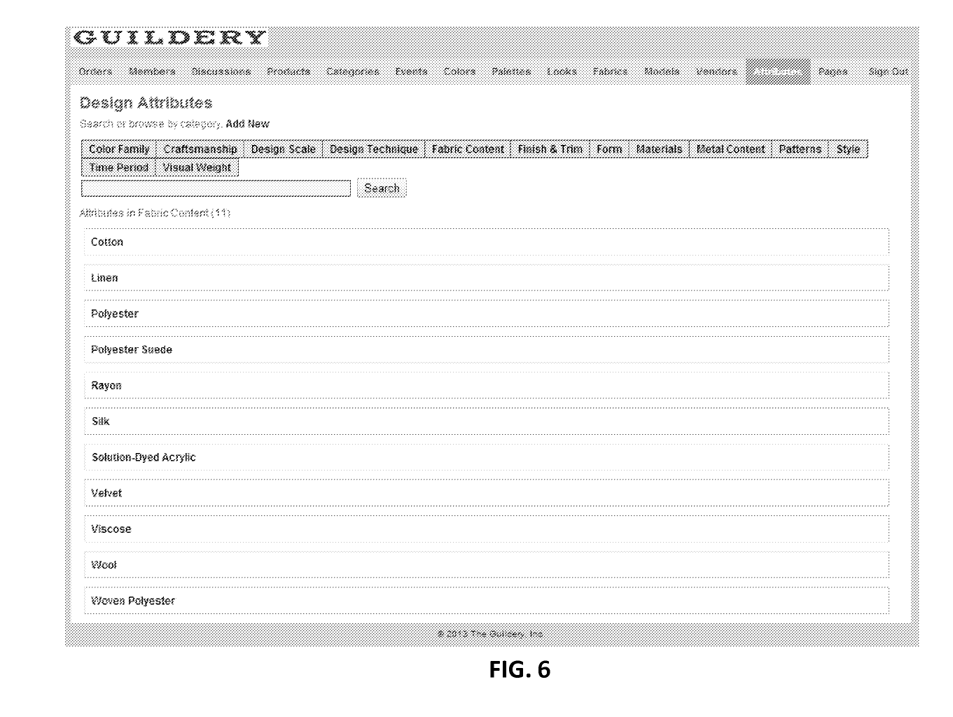

Several exemplary user interface features are illustrated in FIGS. 2-6. For example, FIG. 2 illustrates a user interface for entering a particular fabric, FIG. 3 illustrates a user interface for selecting a particular color for a fabric, FIG. 4 illustrates a user interface for viewing products produced with a particular fabric, FIG. 5 illustrates a user interface for viewing available fabrics, and FIG. 6 illustrates a user interface for selecting fabric content.

Design Genome Search Engine 101

In one embodiment, the core of the platform is a search engine 101 that indexes every product based on numerous design attributes (e.g., hundreds, thousands, etc). This is beneficial because interior design products are decorative items that can not be defined by a simple category. People with extensive domain knowledge including product designers, surface design artists, and interior designers assign attribute values to each product. The design genome search engine then applies design heuristics to link products that can be combined to create a look for a living space. The search engine can be deployed in many applications including retail shopping and interior design tools.

The design genome search engine includes the following features:
Design attributes database: a relational database with all the available interior design products and their attributes.
Item ranking algorithm: given a list of one or more products, the design heuristics are applied to all the products in the design attributes database to provide a ranked list of products that work best with the input list.
Machine learning: the ranking algorithm is updated and refined based on design heuristics learned by analyzing sets of items created by interior designers.
Color scheme tool: since colors are a primary way to browse looks, the platform includes a design tool to create color schemes. The tool has embedded color theory to allow the user to create any type of color scheme such as monochromatic, complementary, split complementary, triad or tetrad.
Color matching tool: In many cases the end user has one or more items in their living space, and they want to find interior design products that look great with these existing items. The color matching tool provides a simple way to match the primary colors of any item with the colors in the platform database. The user opens the tool on any computing device with a high resolution display and camera and holds it up close to the item. The camera captures the color from the item and shows the color on the device display. The user interface then allows the user to adjust the hue, saturation and brightness of the color to visually match the color of the item as perceived by the user.

In one embodiment, the design genome search engine uses the following attributes to index and match products:
Design style: the artistic style of the item such as modern, tropical, eclectic, art deco, abstract, industrial, cottage, traditional, minimal, Asian, country, Victorian.
Colors: the proportion and hue/saturation/brightness of the colors included on the item.
Patterns: the design patterns on the surface of the item such as squares, plaid, diamond, paisley, zigzag, vintage, stripes, dots, damask, toile.
Design scale: the scale of the design pattern such as small, medium or large.
Design technique: the specific medium or artistic technique used on the item such as water color, line art, pencil drawing, photograph.
Materials: the proportion of the material content of the item including wood, glass, plastic, fabric, metal, ceramic, concrete.
Form: the overall lines of the item such as curved, straight, interconnected, boxy.
Visual weight: defines the distribution of the mass of the item such as bulky, delicate, lowslung, topheavy.
Craftsmanship: the quality of the construction of the item such as handmade, handpainted, mortise and tenon, machined.
Finish & Trim: defines the design details included on the item such as pleats, tassels, fringe, pom poms, ribbon, gold, claw feet, chrome, brass, monogram, distressed, nail heads.
Fabric Content: the proportion of materials used in the fabric on the item such as wool, cotton, linen, silk, rayon, polyester, velvet, solution-dyed acrylic.
Metal Content: the proportion of metal types used on the item such as steel, aluminum, lead, copper.

One embodiment includes an item ranking algorithm which uses the following design heuristics to rank products based on one or more input products. For example, a user may input a particular product owned by the user or a product which the user is interested in, and the item ranking algorithm will determine other products which may be combined with the input product in accordance with the following variables:
Similar or contrasting design style: the most preferred approach is to select items that have the same design style, but in some cases the algorithm will suggest a contrasting design style to create variety and interest in the overall look.
Color scheme: items are ranked based on their proportion of colors and how well they match the colors in the color scheme chosen for the look while keeping overall colors in the look in the correct proportion using the 60-30-10 (system of trios) design heuristic. For example, if the items already in the look use the primary color, the algorithm will give higher rank to products with the secondary or accent colors.
Pattern similarity, variety and combinations: the algorithm gives high ranking to products with similar patterns or, if the pattern is used in several items in the look, it will give higher ranking to other patterns or solid colors based on combinations of patterns that are known to be appealing to most people.
Color coordination and variety: the algorithm gives higher ranking to products with the same colors and different proportion of those colors. For example, for an input product with higher proportion of color A than color B, another product that is mostly color B will rank higher than a product that is mostly color A.
Design scale variety: a look is more appealing if some items have larger scale design patterns while others have smaller scale design patterns.
Materials and texture variety: the algorithm uses the materials, fabric content and metal content attributes to rank products based on the materials of the items in the look.
Form similarity and contrast: the algorithm uses the form attributes of products to give higher ranking to those with similar form lines. For example, if the look has a chair with curved lines, the algorithm will give high rank to lamps and accessories with curved lines. If the look has several curved items, the algorithm will give high rank to a simple coffee table, for example, with contrasting straight lines to provide some interest to the look.
Visual weight similarity and contrast: the algorithm uses visual weight attributes of products to give higher ranking to similar or contrasting products based on the items in the look.
Craftsmanship similarity: products with the same craftsmanship as other items in the look are given higher ranking.
Finish and trim similarity: products with similar finishes or trim options are given higher ranking to provide a cohesive look.

Color Library

Another feature of one embodiment of the platform is a color library containing a database of colors and color schemes that can be used in customizing the products in the system (see, e.g., the discussion below related to the colors database 711 and colors system 710 shown in FIG. 7). The colors are tested and verified for print quality and manufacturing to enable artists and designers to use the colors on any designs. A group of colors can be defined as a color scheme. Artists can use the colors and color schemes to setup colorways for fabric and product designs. The colors are used in the merchandising tools to create color schemes for curated sets of products. In addition, end customers and interior designs can use colors and color schemes to customize products.

One embodiment of the color library includes the following features:
Colors: A database of individual colors with a unique identifier that can be used to link colors across the platform. For example, a user can search all the products that have a specific color. A color has attributes including name, number, RGB value, CMYK values and color family.
Color Stories: Two or more colors can be combined to create a color scheme called a color story. The colors may be chosen using color theory to create any type of color scheme such as monochromatic, complementary, triad, tetrad or custom. The color stories are used to setup coordinated sets of designs and products.
Color Match Tool: It is often necessary to match a given color. The color library includes a tool to capture a color from a physical item or input a color value to find the closest matching color in the color library.
Match Colors to Paint Colors: The colors in a color story are matched to the closest paint colors in the platform to recommend paint colors that coordinate with the colors used on any product in the platform.
Match Colors to Fabric Colors: The platform may include a database of fabrics manufactured with traditional methods and not produced on-demand. The colors in the fabrics are matched to colors in the color library, and then the colors in a color story are matched to the closest fabric colors to recommend fabric colors that coordinate with the colors used on any product in the platform.
Colorways Generation: The largest benefit of the color library is to easily generate colorways for a fabric pattern. An artist can create a pattern in one colorway and the platform can generate any number of additional colorways to make the pattern available in many colors. A store manager or interior designer can create a design kit with any color story and if the selected patterns are not yet available with the color story, the platform can generate the colorways for the color story.

Design Kits

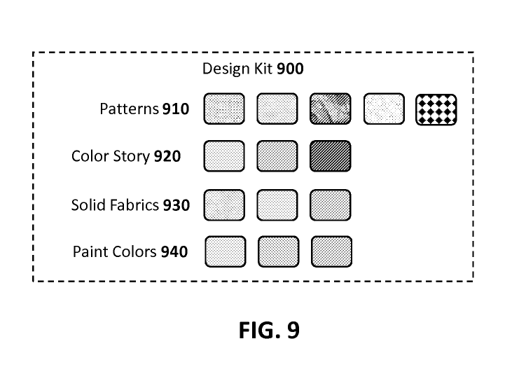

One embodiment of the platform includes merchandising tools to enable store managers or interior designers to create coordinating sets of products called Design Kits (see, e.g., the description associated with the design kits database 751, design kits module 750 in FIG. 7 and the exemplary design kit 900 shown in FIG. 9). In one embodiment, a design kit contains a curated set of design attributes that are used to select a set of products that coordinate such that any combination of products within the design kit can be arranged into an attractive interior design. The design kits can be used to provide a simple shopping experience for end users since the design attributes have been chosen by a designer and the resulting set of products from the design genome search engine is curated to minimize the number of choices. For example, rather than providing an input product to the search engine, the user may select a design kit as input to the search engine, which will then execute its algorithm to select compatible products.

One embodiment of the design kits technology includes the following features:
Design Kits database: A library of design kits is stored in a relational database. A selection of design kits can be provided to platform users to allow them to customize them by changing any of the attributes or products included in the design kit.
Design Kit Editor Tool: A design kit can be created by any platform user with permissions. A design kit can be setup with a list of design attributes such as design style, pattern types or materials. The design genome search engine returns the set of products that match these design attributes to enable the user to select the products to include in the design kit. A design kit can also be setup with a set of specific patterns, fabrics, and paint colors and the user can select products with these patterns and fabrics to include in the design kit. Alternatively, a design kit can be setup with any set of products from the products database.
Design Kit Categories: A store manager can setup shopping pages with a list of design kits that are published in an e-commerce application for browsing or searching by end customers. The end customers can select a design kit and browse the set of products included in the design kit. This provides a simple shopping experience because the end customer knows any combination of products from the design kit will coordinate in an interior design arrangement.

Product Imaging Engine 102

Another feature of one embodiment of the platform is imaging software to enable users to visualize how products look with any of the available material options such as fabric designs, colors and finishes. It would be incredibly expensive to make physical samples of every product with every option. The solution to this problem is digital imaging software that allows the user to create a model of the product and options with photographs and 3D design files, and the software automatically generates images of the product with any of the options. The imaging software can generate images of the product at any viewing angle with lighting highlights and shadows to create photorealistic images for printing or viewing on any device.

One embodiment of the product imaging technology includes the following features:
Product models: a set of digital photographs or 3D design files that define the product such as a chair, ottoman, rug, pillow, drapery panel, plate or bed. The model can contain options that can be changed by the end user such as the size of the arms for a chair, the length of a sofa, legs of a chair, trim options like nail heads on an ottoman. The lighting highlights and shadows for the product can be input as layer images that are composited over the product model to create the final photorealistic images.
Surfaces: a product can have any number of surfaces such as the wood panels on the side of a chair or the pieces of fabric on an upholstered ottoman or throw pillow. Each of these surfaces can be changed with different fabric or material images to allow the user to visualize the product with any of the available options.
Fabric images: images or design files of fabrics in all available colorways are uploaded and the texture image of the fabric is composited to create high resolution digital images that are used as virtual fabric on the product model surfaces when generating the product images.
Material images: images or design files for optional materials such as wood finishes, metal finishes or plastic colors are uploaded and used as options on the product model surfaces when generating the product images.
Surface color: Some fabric designs can be digitally printed in any color combination. The fabric designs are uploaded to the platform in one or more colors, and the platform software can change the colors to any other color combination. The software generates a new fabric image that can be used as virtual fabric on the product model surfaces to allow the end user to visualize any product with the new fabric design.
Personalization: a product can be setup with surfaces that can be personalized by the end user such as monograms or photos that can be imprinted or embroidered on the finished product.
Image generator: the image generator inputs the product model, surfaces, fabric images, material images and personalization data to generate the photorealistic images that are printed or displayed on an electronic device.
Look design tools: the platform includes applications to view a set of product images together as a complete look. Looks may be created by a community of interior designers or by the end user.

Digital Sampling and Feedback System

One embodiment of the platform includes a digital sampling and feedback system to enable pattern artists and product designers to quickly and efficiently get feedback on new designs (see, e.g., the discussion below related to the voting system 730 shown in FIG. 7). In the past, new patterns and product designs were created mostly in private and then made available to potential buyers by manufacturing a quantity of physical products. With digital sampling the artist or product designer can upload new design files to the interior design platform and get feedback from the community of potential buyers without the time and cost required to make physical samples.

One embodiment of the digital sampling and feedback system includes the following features:
Community Database: A library of community members is stored in a relational database with attributes to describe each user including type of member (artist, product designer, interior designer, store manager, end customer) and a profile of design preferences. Community members may also follow pattern artists, product designers or interior designers to receive updates from them.
Digital Sample Kit Editor: A pattern artist or product designer can create a new sample kit with one or more design files and select the criteria describing which community users are allowed to view the sample kit and provide feedback.
Sample Kit Distributor: An algorithm is run to determine the optimal list of community members to send the digital sample kit. In order to maximize the value to the designers and the community members, the distribution list must be chosen very carefully. The designers want to get feedback only from community members who can provide constructive feedback, and community members only want to view sample kits that match their design preferences. The algorithm may employ a number of criteria to determine the distribution list including type of community member, reputation of the designer and community member, follower lists, design attributes of the sample kit, and design preferences of the community member.
Sample Kit Feedback Form: A community member who receives a digital sample kit can review the digital files and complete the feedback form. The feedback may include a numerical rating, a binary like/favorite rating, and detailed comments.
Sample Kit Report: A pattern artist or product designer can view all the detailed feedback and a report summary. Based on this information, the designer may decide to remove the design, modify the design and send the revised sample kit to the community, or finalize the design and offer it for sale in the platform.

3D Modeling Engine 103

It is helpful if the end user can visualize a set of interior design products in their living space. The architecture, size and lighting of the space can have a significant impact on the overall look. The use of 3D models to visualize interior design products in a room setting is not new, but the solutions available to date have not been easy enough for most consumers and did not provide photorealistic images for making an informed decision about the items. One embodiment of the platform aims to solve these problems using novel technologies and user interface design techniques. The end user simply captures one or more digital photographs of a room or living space, and the 3D modeling software constructs a 3D model.

The end user or a designer can then add interior design products such as paint, wallpaper, flooring, rugs, furniture and decorative accessories to the room and visualize the overall look.

One embodiment of the 3D modeling technology includes the following features:
Product models: a 3D model is associated with each interior design product in the database. The 3D model can be created by a designer in a 3D design application, or the product can be scanned using a 3D scanner to create the 3D model. The product is photographed and the photographic images are mapped to the 3D model to create a photorealistic 3D model that can be rotated in any direction with lighting highlights and shadows generated and rendered on the product based on the light sources of the 3D room model. The surfaces of the product that have options such as fabric or wood finishes are rendered using photographic images of the surface materials. This allows the end user to place a product into the 3D room model and see how it will look with the lighting in the room, and then change the fabric or finishes of the product and immediately see how the look changes.
3D reconstruction: the three dimensional data for the room model are reconstructed from the photographs of the room. The architectural elements of the room including the doors, windows, floors, walls and ceiling are detected using computer vision techniques.

The angles of the walls and floors to the viewer are used to calculate the distance from the viewer to each point on those surfaces and the density of the image in pixels per unit of measure at each point on those surfaces. These data are employed to scale the product models to the accurate size as the user moves the product around in the 3D room model.
Image-based rendering: to provide photorealistic views of the 3D model, high resolution photographic images are mapped to the surfaces of the 3D space. Images of the products and material surfaces are used to render the product models in the 3D space.
Dynamic lighting generation: shadows and highlights on the products added to the 3D room model are very important to provide photorealistic views and allow the end user to visualize how the ensemble of interior design products will look in the room. The direction and intensity of the light sources in the room are determined from the room photographs or by user input. The light source data are then used to calculate the light absorption and reflection on each 3D product model surface facet and render the highlights and shadows on each product in the 3D room model.
Room model image generation: the end user can save any view of the 3D room model with interior design products and the platform generates a high resolution image of the view that can be printed or shared electronically.

On-Demand Fulfillment Engine 104

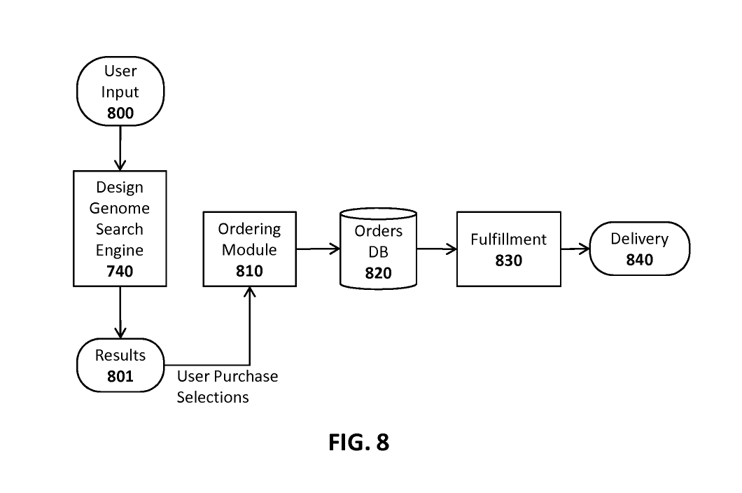

One embodiment of the platform includes a fulfillment system to facilitate the delivery of interior design products that are assembled into a look by the end user (see, e.g., the discussion related to the fulfillment module 830 shown in FIG. 8). Because there are a very large number of products and combinations of products, an on-demand manufacturing and fulfillment system is required to provide fast delivery with the lowest possible cost. In most cases, the finished products are not made until the customer places the order. The raw materials and partially-assembled products are connected in the supply chain to provide just-in-time manufacturing in a facility that is closest to the end customer.

One embodiment of the on-demand fulfillment system includes the following features:
Fulfillment products: a relational database with all the available interior design products that can be manufactured and delivered to a customer. The fulfillment products can have customization options such as fabrics, wood finishes, paint colors or trim.
Artwork file customization: the order data includes customization options such as fabric colors and trim options. The fulfillment system manages the storage of the artwork files in a distributed file system to minimize the time required to send the file to the fulfillment site. When an order is sent to a fulfillment site, the file stored closest to the fulfillment site is retrieved and colorways generation software applies the colors and other customization options to the file to create the final order artwork file.
Order print file creation: each fulfillment product that requires fabric has attributes that define the number and size of fabric surfaces needed to manufacture the product. The fulfillment system software uses the final order artwork file to create final print files for each of the fabric surfaces.
Print batch file generation: The digital textile printers are wide-format machines with print widths from 54 inches up to 126 inches. In order to feed the digital textile printers with print files, many final print files are imposed in an optimized layout based on the width of the fabric to minimize waste. The imposition can be managed by the printer software, or the fulfillment system software can generate print batch files with the final print files imposed for printing.
Fulfillment sites: every facility that can manufacture fulfillment products and deliver them to customers is setup as a fulfillment site with a physical location. Each fulfillment site is setup with the fulfillment products that it can make and deliver with inventory level and daily fulfillment capacity. The fulfillment site can enter their daily fulfillment capacity and set their price for each fulfillment product.
Order router: Each customer order is routed to a fulfillment site or multiple fulfillment sites based on the shipping address of the customer, shipping priority level, and best overall cost. The shipping delivery speed is selected by the user between standard and expedited. For standard delivery, cost is prioritized so the fulfillment sites are selected based on the lowest cost. For expedited delivery, the fulfillment site is selected based on the ability to deliver within the committed delivery date and the lowest cost. The overall cost is calculated based on the shipping costs and the fulfillment product cost. Each fulfillment site can set their price on each fulfillment product, and they can set their daily capacity. Fabric is ordered from one fulfillment site and delivered to another fulfillment site to make the finished item. The order router informs the fulfillment sites of the current cost of each fulfillment product across the fulfillment sites to inform them of the current market price so they can set a price that will allow them to receive orders. The fulfillment product price is dynamically calculated for each order to yield the best price for the fulfillment site and the lowest cost for the fulfillment system.
Fulfillment site reputation: The quality of each product delivered to customers is of utmost importance. A reputation system provides the feedback from customers to incentivize each fulfillment site to maintain top quality with each product manufactured and delivered to customers. A survey is sent via email or text message to the customer after each order is delivered. Negative reviews are counted against the fulfillment site, and if a fulfillment site receives an average score below a specific threshold, the fulfillment site will not receive any new orders.
Predictive supply chain: The fulfillment system analyzes past customer orders and order forecasts to place supply orders for materials and partially-assembled products for inventory in the fulfillment sites. Events for new products and promotions are planned in advance and quantity of each fulfillment product and fabric is estimated for each fulfillment site. For example, an event with a red velvet fabric on an ottoman is planned for two weeks in the future. Based on past orders through each fulfillment site and growth of the number of customers in their fulfillment area, the estimated quantity of red velvet fabric and partially assembled ottoman frames is ordered for delivery to each fulfillment site.
Order tracking tool: Each fulfillment site uses the order tracking tool to get the real time prioritized list of orders that are ready for manufacturing and delivery to the customer. Each fulfillment site employee simply views the list on an electronic device that is connected to the internet and fulfills the order at the top of the list. The tool clearly shows the priority status of each order so the maker knows if the order needs to ship today or can be shipped the next day.
Inventory tracking and just-in-time replenishment: The fulfillment system tracks inventory of the parts required to manufacture the fulfillment products. The inventory is tracked for each fulfillment site so the software knows where inventory is available throughout the distributed fulfillment system. As parts are converted into finished products, the inventory of parts is updated based on the quantity used. A minimum quantity trigger can be set for each part to allow the fulfillment system to automatically order more parts when the inventory quantity is at or below the minimum quantity.

### Exemplary Implementations

Design Search In Online Shopping Flow

One embodiment of the interior design platform integrates the design genome search engine in an online shopping flow to provide a list of recommended products based on a list of one or more input products. In one example software implementation, the user browses design kits from an online catalog. After selecting a design kit, the user places a product in the online shopping cart. The design genome search engine uses the product as input to produce a list of recommended products that coordinate with the input product.

The design genome search engine starts by retrieving the design attributes for the product and creates a vector of all the design attributes. All the design attributes are then retrieved from the products database and stored in a vector for each product. The list of products may be filtered by product type to only return products of those types (e.g., pillow, lamp or chair). For a design kit, only the subset of products included in the design kit may be retrieved. In one embodiment, the design genome search engine then computes a distance value for each product based on the following algorithm:
A set of weights are setup for the various types of attributes. These values are adjusted to tune the search algorithm. Sample values are given below:
   designStyleWeight=100
   fabricWeight=1000
   fabricColorWeight=20000
   designScaleWeight=1000
   patternWeight=2000
   productColorsWeight=5000
Products with the same fabric as the input product are given a higher distance (lower rating) by adding the fabricWeight to the distance value.
Products with the same fabric color are given a higher distance by adding the fabricColorWeight value.
Products with different pattern types are given lower distance by calculating the difference of all the pattern type attribute values, multiplying the total difference by the patternWeight value, and then subtracting the result from the distance value.
Products with different design scale are given lower distance by calculating the difference of all the design scale attribute values, multiplying the total difference by the designScaleWeight value, and then subtracting the result from the distance value.
Products with the same design style are given lower distance by calculating the difference of all the design style attribute values, multiplying the total difference by the designStyleWeight value, and then adding the result to the distance value.
Products with different colors are either excluded from the results or given higher distance by calculating the total difference between the HSV color values for each color used on the products and then multiplying this difference by the productColorsWeight value and then adding the result to the distance value.

The list of products included in the search results is sorted by the distance to get the recommended set of products at the top.

Colorways Generation

One embodiment of the interior design platform includes a colorways generation system. An artist can create an artwork file in one colorway and the platform can generate any number of additional colorways to make the artwork available in many colors. A store manager or interior designer can create a design kit with any color story and if the selected artworks are not yet available with the color story, the platform can generate the colorways for the color story.

The color library contains a database of colors and color stories that were created by designers with the color story editor tools. Each color story contains one or more colors that are coordinated so that products in those colors will look good together. The color story includes metadata to describe which combination of colors can be used together to create colorways for artworks and products. Not all combinations are enabled since the colors may not have enough contrast to use together on the same product.

The software flow for colorway generation is as follows:
The artwork file is uploaded to the platform with the colorway defined by the colors used in the pattern artwork file.
The product imaging engine creates preview images of the artwork on each product model.
The user reviews the artwork on each of the product preview images to visualize how the artwork looks on various products.
The user can modify the scale of the artwork on any product or disable the artwork on any product to adjust which products should be made available with the artwork and what scale it should be on each product.
The user selects one or more color stories.
The colorways generation software creates a preview image of the artwork file in each of the colorways enabled for each color story.
The colorways generation software creates a preview image of each colorway on each of the products enabled for the artwork.
The user can review all the colorways on each product to select which ones should be available to end customers.
The colorways generation software then publishes the products and colorways to the online shopping catalog to allow end customers to view and purchase the products.
After the end customer purchases a product with a specific colorway, the colorways generation software then creates the high-resolution print file by changing the colors used in the artwork file to the colors used in the colorway.

Detailed Architectural Components

A more detailed exemplary system architecture illustrated in FIG. 7 includes various different patterns 700 stored in a patterns database 701 and different color combinations 712 stored in a colors database 711. In one embodiment, the colors 712 are arranged in the colors database 711 by grouping sets of colors which are known to work together for design purposes (e.g., colors that match), sometimes referred to as “color stories” or “colorways.” These color stories may be preselected, for example, by designers. The patterns 700 may include any form of design pattern usable on any type of home furnishing (e.g., sofas, drapes, pillows, etc).

In one embodiment, a colors system 710 manages the integration between the various patterns and the different color stories. For example, in one embodiment, the colors system 710 maps different color combinations from each color story (which are known to work together) to the patterns in the patterns database 701. In this manner, the colors system 710 may map any of the color stories within the colors database 711 to any existing pattern within patterns database 701, resulting in colored patterns with colors that are known to work together and which are also capable of being manufactured with existing techniques. In one embodiment, a color story may be created using between 2-5 colors selected by a designer.

Whenever a new pattern is added to the patterns database, the colors system 710 may automatically select an appropriate set of color stories to be applied to the pattern based on the number of colors required by the pattern. For example, if a pattern requires four different colors, then one embodiment of the colors system 710 will automatically select color stories with four different colors and apply each of those color stories to the pattern. In one embodiment, the colors system 710 implements a mapping algorithm to determine which specific colors from each color story to map to each specific design element within the pattern (e.g., leaves, geometric shapes, background, etc). In one embodiment, each design element within the pattern is assigned a specific number which indicates the color within each color way to be mapped (e.g., color 1, color 2, etc). In one embodiment, colors are assigned based on attributes of the different design elements of each patterns (e.g., the amount of space consumed by the design attribute, etc).

In one embodiment, when an end user selects a particular pattern and set of color stories, the colors system generates a visual representation of the colored pattern for review by the end user. In addition, a product imaging system 720 visually maps the newly created colored patterns to one or more products, data for which is stored in a product models database 721. In one embodiment, the imaging system 720 includes all of the features of the imaging engine 102 described in detail above (as well as additional features). The product models database 721 may store 2D and/or 3D models comprising images and/or graphics design data for any type of products (e.g., pillows, furniture, drapes, wallpaper, etc). The product imaging system 720 may map the colored patterns to each of the products and render an image of the final result on a display of the end user. In addition, the resulting images of products (or a selected subset thereof) may be stored within an imaging file system 723. In addition, a products database 722 may be updated to include specifications, product attributes, and/or final images of products with specific colored patterns.

In one embodiment, designers who are provided with administrative access to the system select product models from the product models database 721 and choose colored patterns which have been generated by the colors system 710 (e.g., by combining patterns with the color stories) to be applied to each of the product models. The results are then stored in the image file system 723 (as images) and the products database 722.

In one embodiment, a voting system 730 is implemented to allow designers and/or end users to vote on different product images stored within the image file system 723, thereby providing a review and filtering process for different product images. In one embodiment, the opinion of certain voters will be weighted more heavily than other voters. For example, the opinions of designers may be given greater weight than the opinions of end users and certain designers may be given greater weight than other designers. In one embodiment, voting is performed on a simple numerical scale (e.g., 1=highly favorable opinion, 5=highly unfavorable opinion). However, various other, more detailed forms of voting may be performed, including the ability to provide comments and other forms of feedback. The results of the voting may be compiled in a voting database 731 and reviewed by the owner/operator of the system. In response, the products database 722 may be updated to add or remove products.

For example, in one embodiment, the voting system 730 is used as a filtering or screening system to determine which products should be added to the final products database 722. For example, designers or users may review images of products in the image file system 723 and vote. The results of the voting may then be stored in the voting database and only those products which have received a number of votes or a score above a specified threshold will be moved into the products database 722. In one embodiment, in addition to product images (i.e., of products with colored patterns generated by the colors system 710), the products database 722 includes product descriptions and attributes which may be used to perform searches by the design genome search engine 740, which may include all of the features of the design genome search engine 101 described above with respect to FIG. 1, as well as additional features.

In particular, the design genome search engine 740 uses the assigned attribute values associated with each product design in the products database 722 to perform user searches to identify products based on user preference and also to locate products which are compatible/comparable to the user's existing products. As discussed in detail above, these attributes may include (but are not limited to) design style, colors, patterns, design scale, design technique, materials used, form, visual weight, craftsmanship, finish & trim, fabric content, metal content, etc. In one embodiment, each attribute has a weight value associated therewith. In one embodiment, the design genome search engine 740 implements the item ranking algorithm described above which uses design heuristics to rank products based on one or more inputs including similar or contrasting design style, color scheme, pattern similarity, variety and combinations (e.g., color coordination and variety), design scale variety, materials and texture variety, form similarity and contrast, visual weight similarity and contrast, craftsmanship similarity, and finish and trim similarity, to name a few.

By way of example, a user may input data related to his/her existing home furnishings (either manually or by snapping pictures) or may select a new product to purchase via the system. The design genome search engine 740 may then analyze the data and execute the ranking algorithm to determine those product designs within the product database 722 which are most suitable for combination with the user's existing furnishings or the product selected. For example, if the user has furniture with solid colors (i.e., non-patterned), then the algorithm may select colored patterned products (e.g., pillows, drapes) which will match with the solid colors of the furniture. In addition, it may select styles and fabrics based on the user's style and fabric preferences. In other words, given a particular pattern with a particular color way for a selected/existing product, the design genome search engine 740 will apply design heuristics using the attributes in the products database 722 and the attributes of the selected/existing products to identify a ranked list of “matches.” The ranked list may then be visually presented to the end user.

One embodiment of the invention also utilizes design kits, which are groups of patterns, color stories, solid fabrics, and paint colors which have been preselected to work together. In particular, in one embodiment, design kits are stored in a design kits database 751 and accessed/manipulated via a design kits module 750. FIG. 9 illustrates an exemplary design kit 900 which includes a set of five patterns 910, a color story comprising three different colors 920, three solid fabrics 930, and three paint colors 940, which all work together and which therefore may be used to select products for a particular room. In one embodiment, the design genome search engine 740 may be used by designers to help build each design kit (although the design kits may be built without the search engine 740). Regardless of how the design kit is built, a designer may first select a set of patterns 910 and then select a color story 920 for those patterns (i.e., to map the colors of the color story to the patterns). The designer may then select a set of solid fabrics 930 and paint colors 940 which will work with the selected patterns 910 and color story 920. The design kit may then be used to select appropriate set of products to present to the end user.

When shopping online for home products, an end user may then initially select a design kit based on the user's preferences. The design genome search engine 740 may then query the products database 722 to identify products which match the selected design kit (e.g., using the algorithm discussed above). Within a particular design kit, a user may mix and match any products and know that they will coordinate.

As illustrated in FIG. 8, in one embodiment of the invention, a user may input search criteria 800 to the design genome search engine 740 which will then generate results (as described above). In addition, the user may then select from these results to specify a purchase. For example, after selecting a particular design kit, the user may choose to purchase a pillow with the selected pattern and color story. The user purchase selections may then be sent to an ordering module 810 which adds one or more records of the order to an orders database 820. A fulfillment module 830 then consumes unfilled orders from the orders database 820 and communicates with one or more fulfillment locations to schedule delivery 840. For example, the fulfillment module 830 may first determine a set of fulfillment centers which are capable of fulfilling the order. It may then select the most appropriate fulfillment center based on geographical location, the window of time within which the user needs the item, and the amount of time it will take each fulfillment center to ship the item (e.g., some fulfillment centers may have the item in stock and some may not, or may need to manufacture the item).

In one embodiment, the fulfillment module 830 evaluates the attributes of the selected product, including the color story, to determine which fulfillment site is to be used. For example, certain fulfillment sites may only be capable of manufacturing with certain types of fabrics and colors.

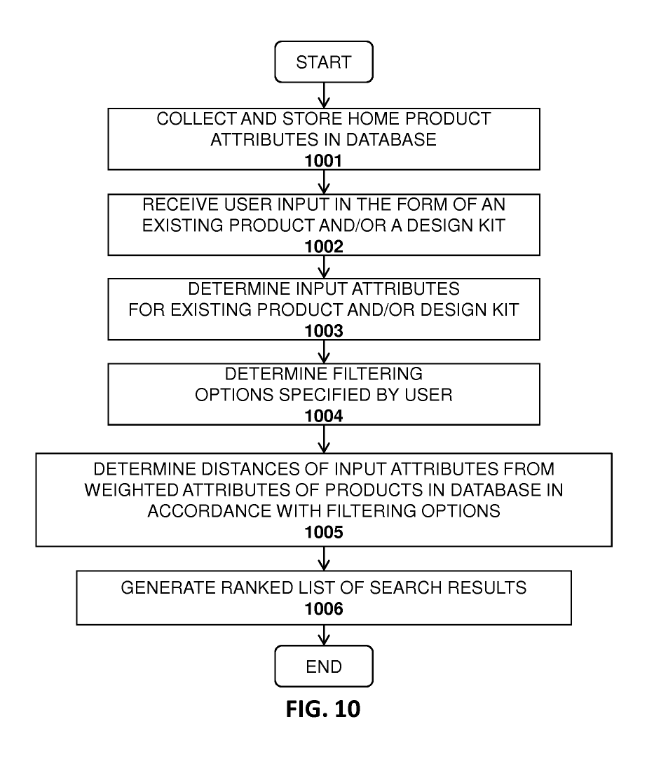

FIG. 10 illustrates one embodiment of a method for performing a search operation. The method may be implemented by the design genome search engine 740 illustrated in FIG. 7, but is not limited to any particular architectural arrangement.

At 1001, various different product attributes are collected and stored in a database (see discussion above related to exemplary attributes that may be used). At 1002, user input is received in the form of an existing product (e.g., either a picture/attributes entered by the user or a product available in the system) and/or a design kit. At 1003, input attributes are determined for the existing product and/or the selected design kit and, at 1004, one or more filtering options specified by the user are determined. For example, the user may choose to only search for pillows or chairs, etc. At 1005, distances between the input attributes and weighted attributes of the products in the products database in accordance with the filtering options. For example, if the user has indicated a desire to search for pillows, then only pillows sill be searched in the products database. As mentioned, each attribute may be assigned a particular weight based on the relevance of that attribute in locating comparable/compatible products. Once all of the distances of the attributes have been determined, and the associated weights factored in, at 1006, a ranked list of results is generated for the user to review. In one embodiment, the items at the top of the list have the closest “distance” to the input product and/or design kit.

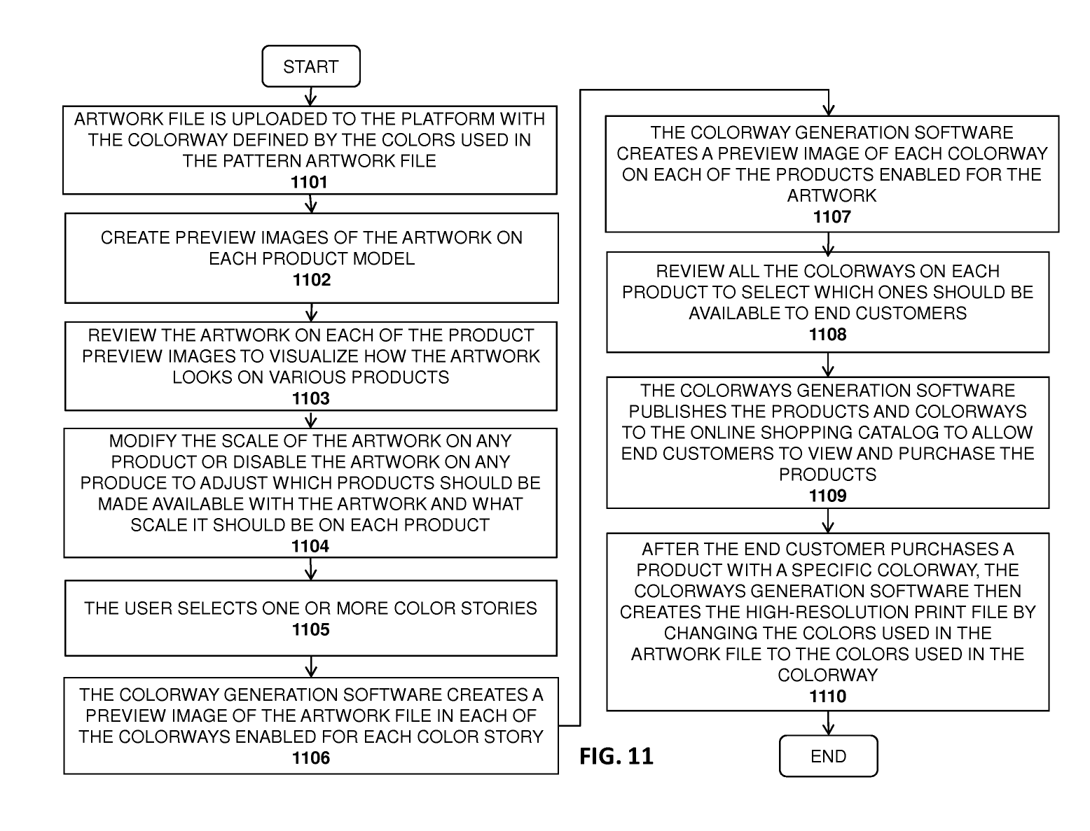

FIG. 11 illustrates one embodiment of a method for colorway generation and processing. The method may be implemented by the color system 710 shown in FIG. 7, but is not limited to any specific architectural implementation. At 1101, an artwork file is uploaded to the platform with the colorway defined by the colors used in the pattern artwork file. At 1102, the product imaging engine creates preview images of the artwork on each product model. At 1103, the user (e.g., potentially a designer) reviews the artwork on each of the product preview images to visualize how the artwork looks on various products. At 1104, the user can modify the scale of the artwork on any product or disable the artwork on any product to adjust which products should be made available with the artwork and what scale it should be on each product. At 1105, the user selects one or more color stories and, at 1106, the colorway generation software creates a preview image of the artwork file in each of the colorways enabled for each color story. At 1107, the colorways generation software creates a preview image of each colorway on each of the products enabled for the artwork.

At 1108, the user may review all the colorways on each product to select which ones should be available to end customers. At 1109, the colorway generation software then publishes the products and colorways to the online shopping catalog to allow end customers to view and purchase the products. Finally, at 1110, after the end customer purchases a product with a specific colorway, the colorways generation software then creates the high-resolution print file by changing the colors used in the artwork file to the colors used in the colorway. The high resolution print file may then be used for fulfilling the order.

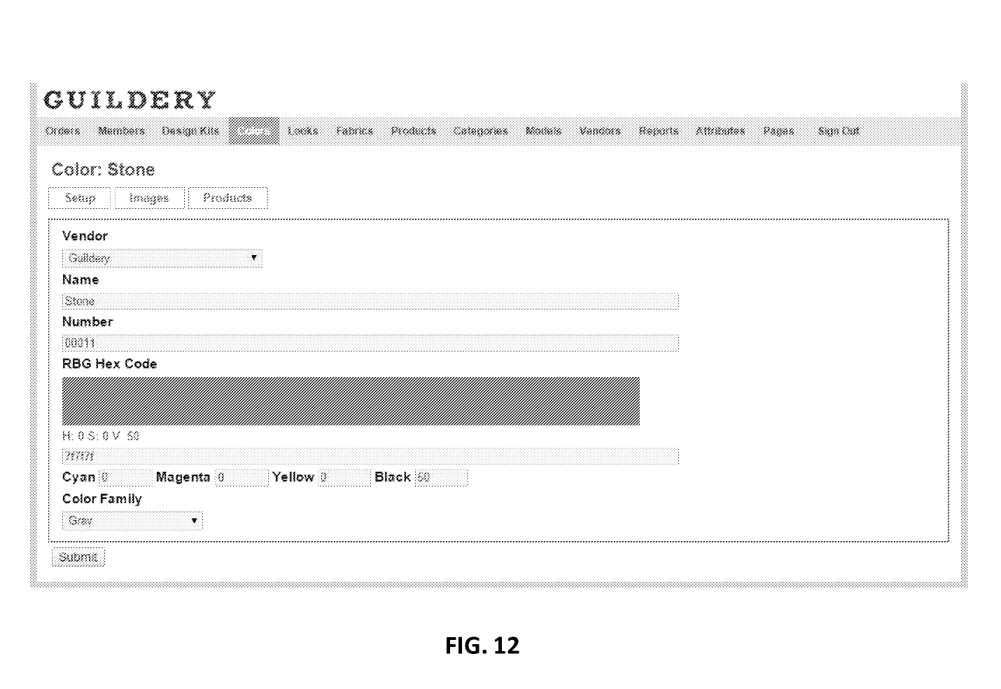

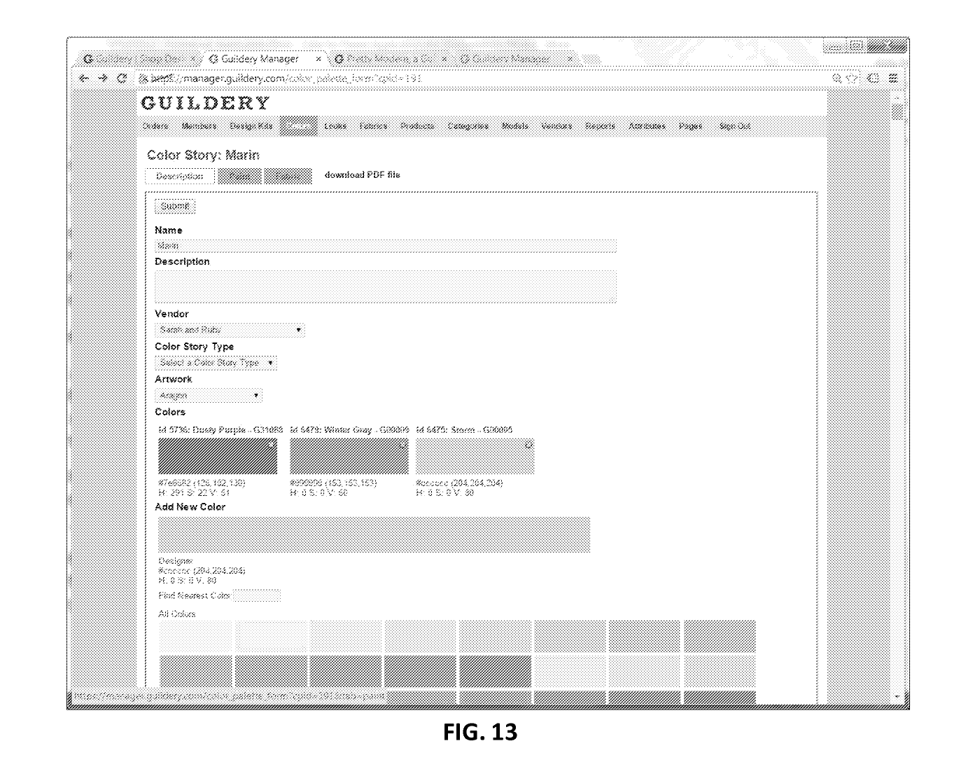

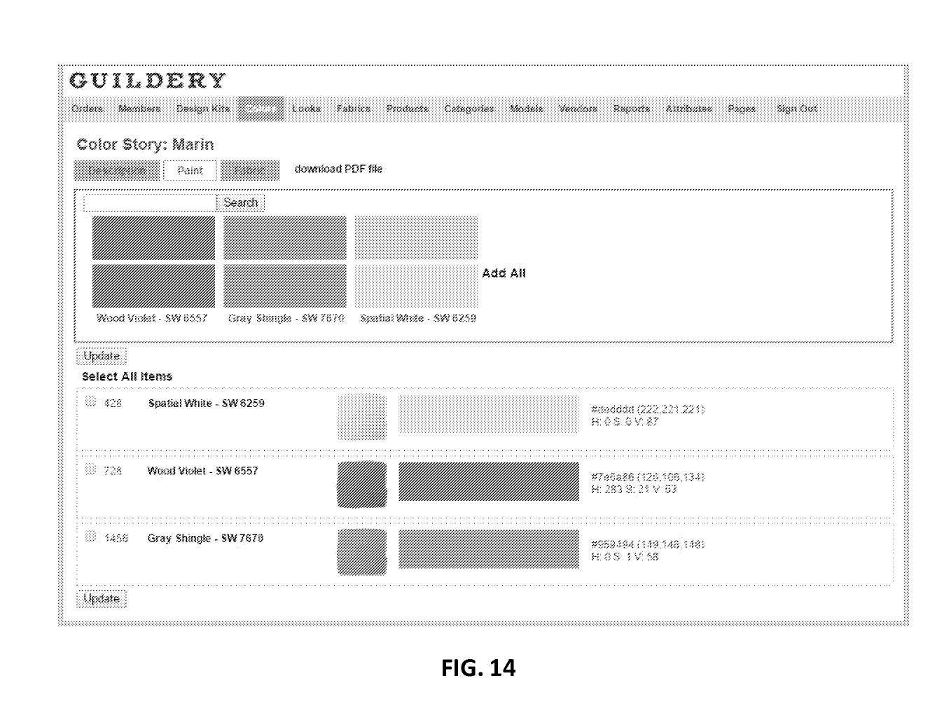

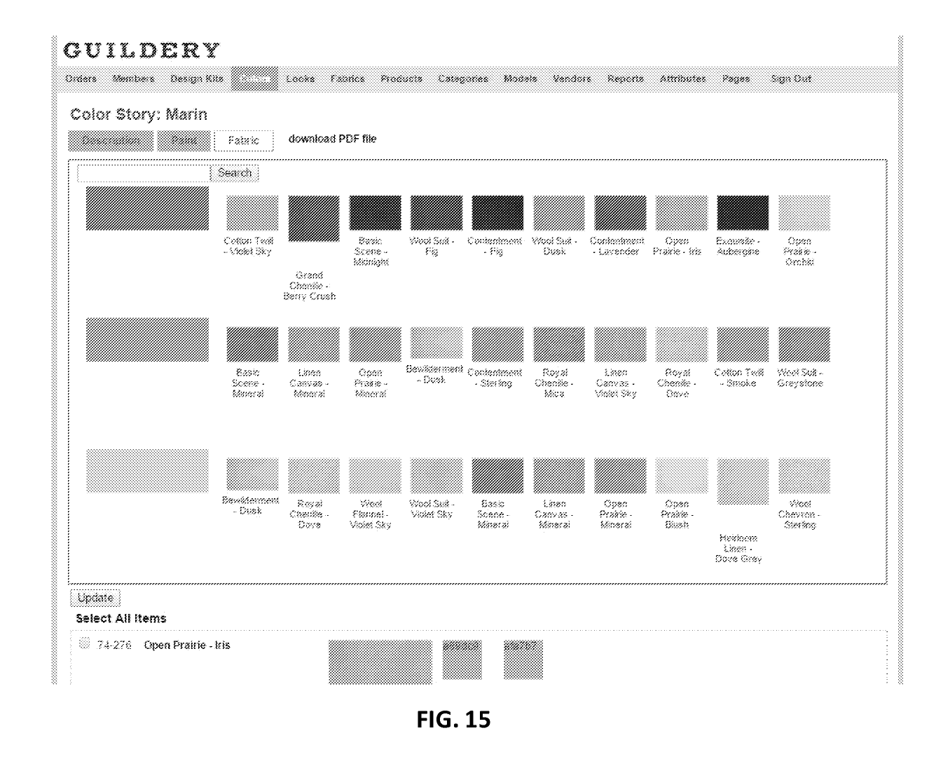

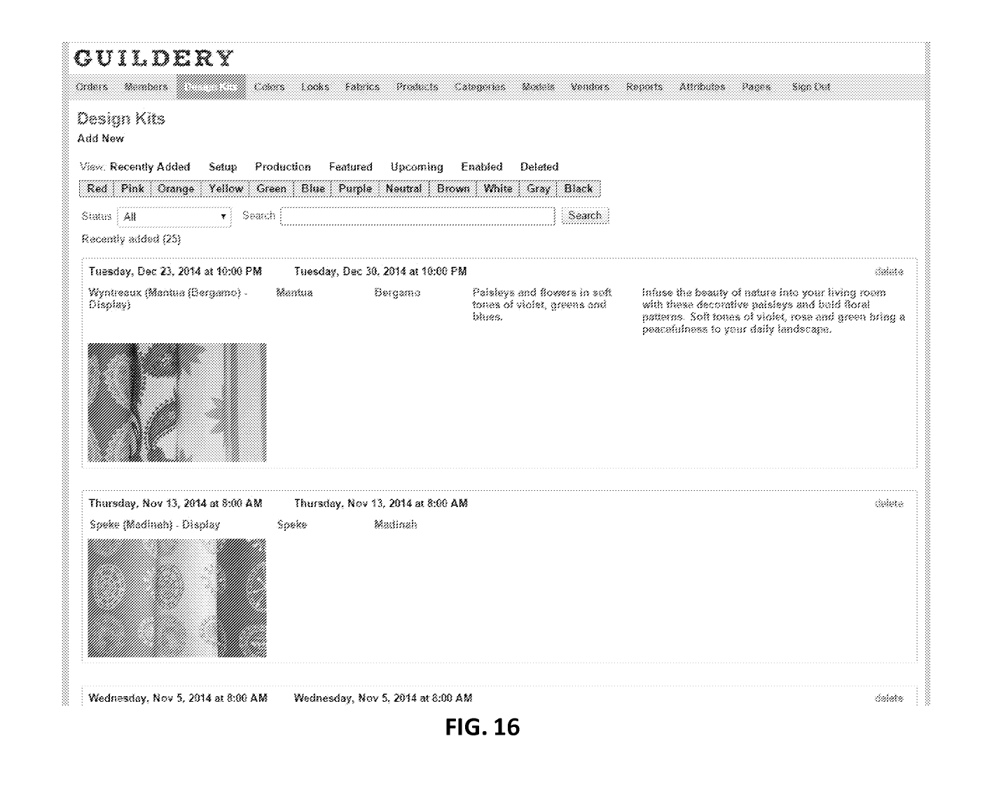

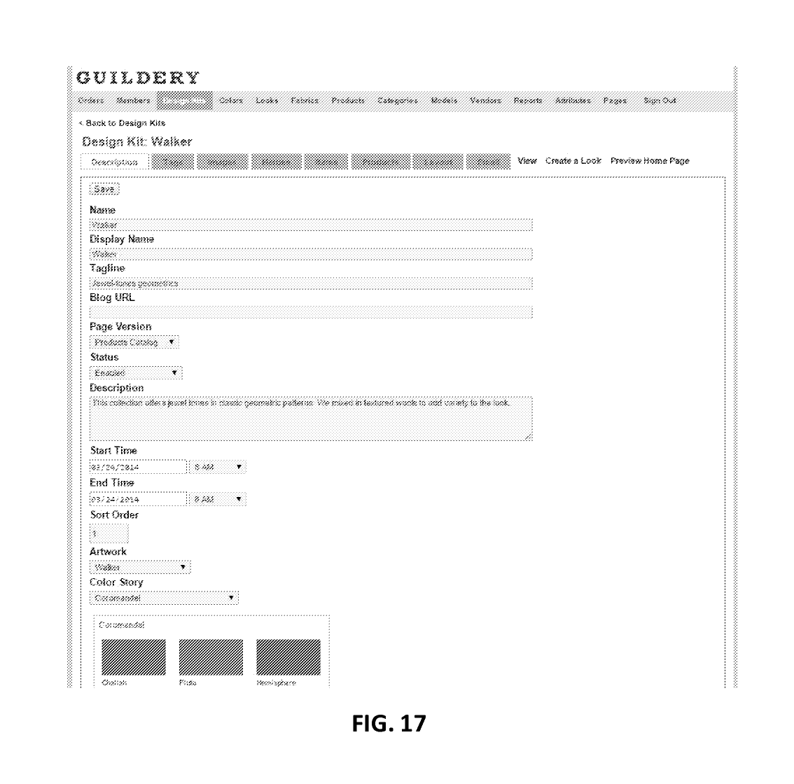

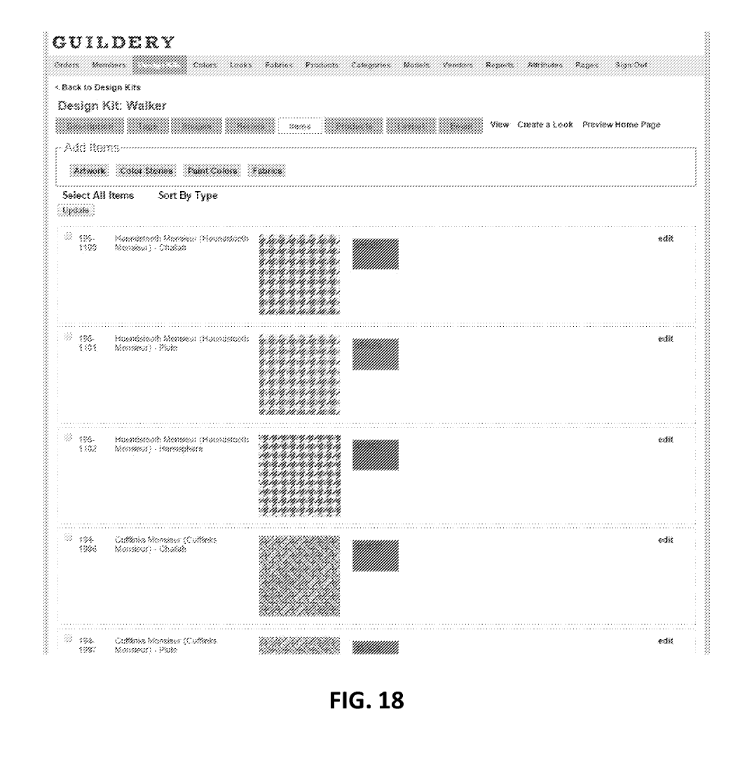

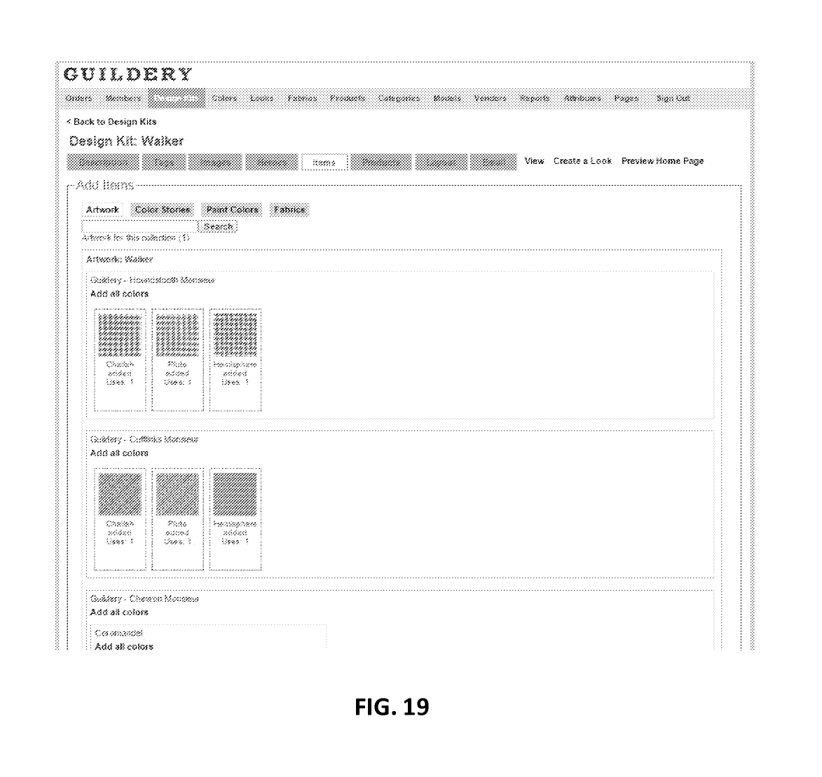

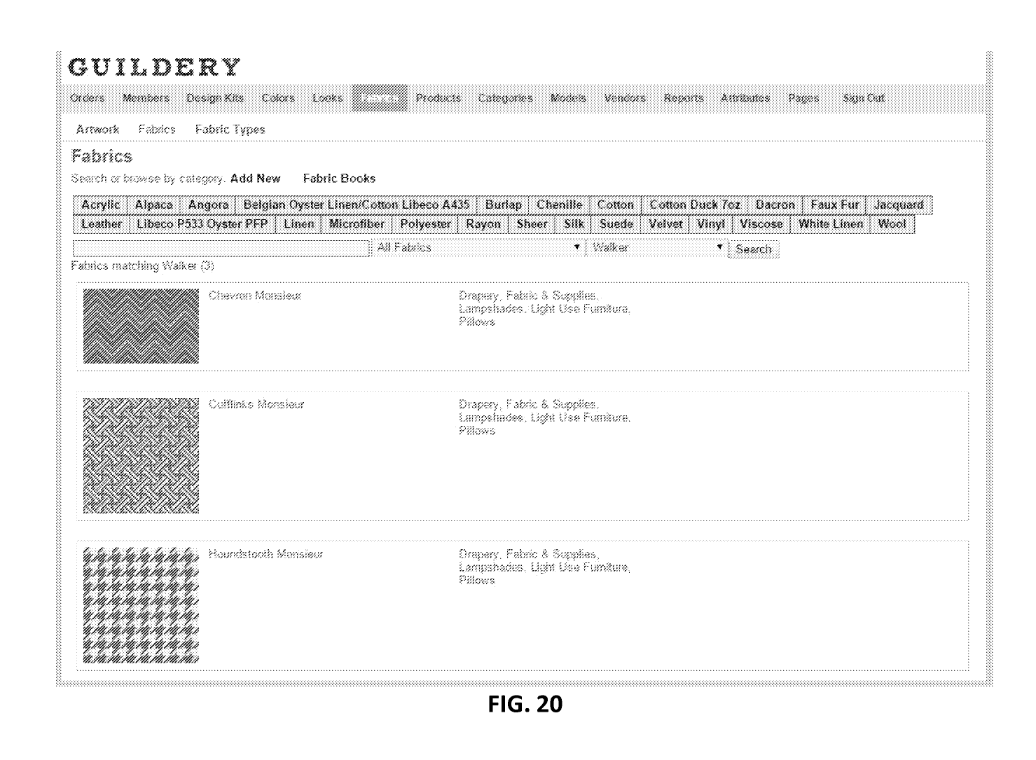

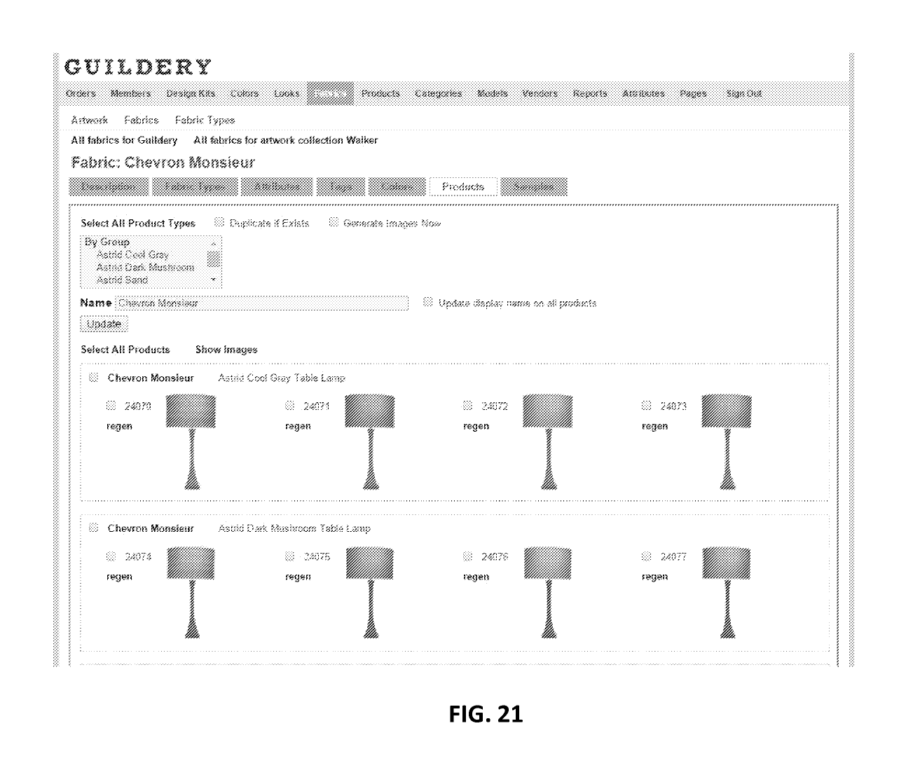

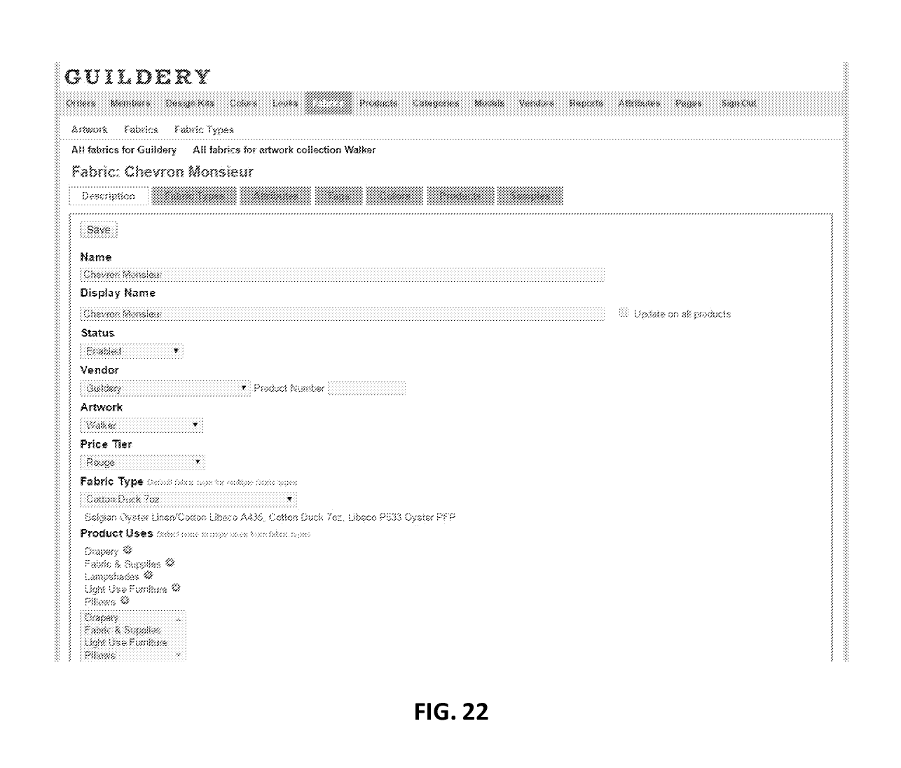

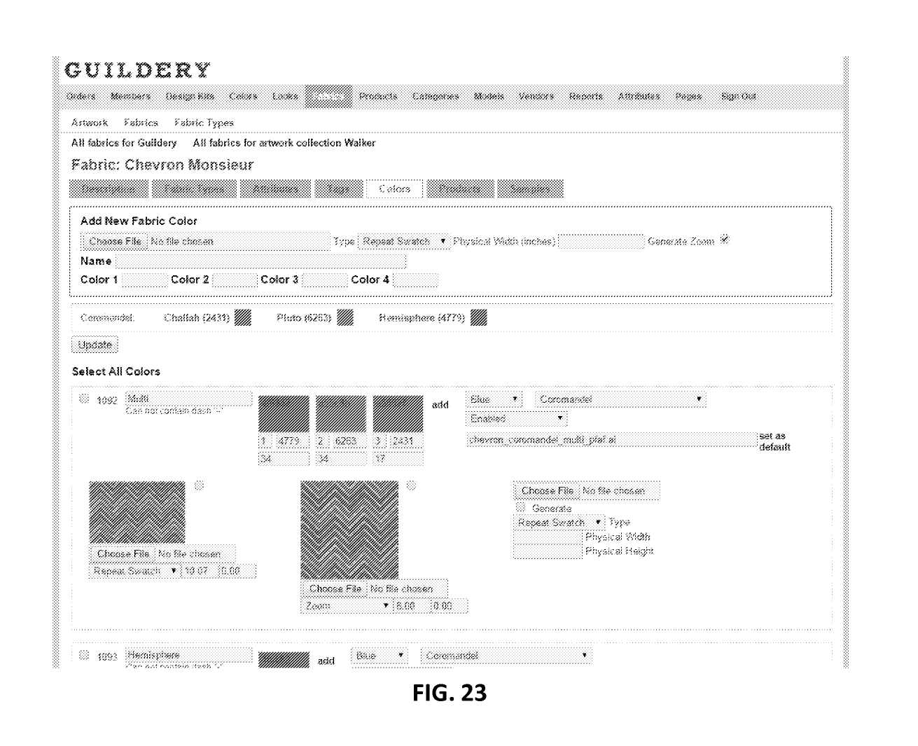

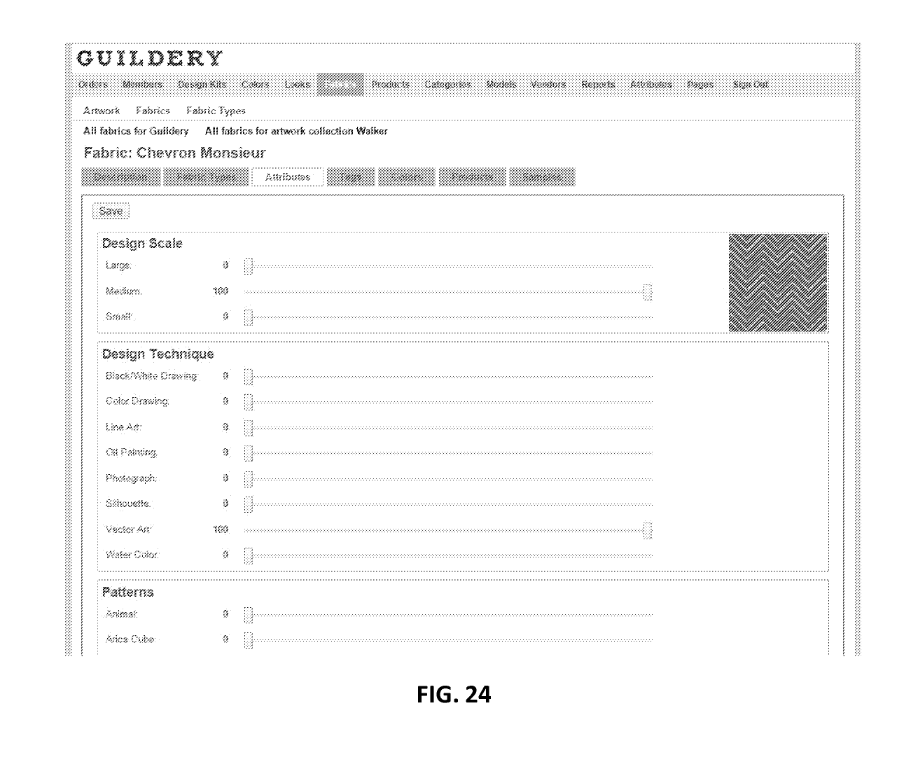

Several exemplary graphical user interface (GUI) features are illustrated in FIGS. 12-24. For example, FIG. 12 illustrates an exemplary GUI for selecting colors, FIG. 13 illustrates an exemplary GUI for color stories, FIG. 14 illustrates an exemplary GUI for color story paints, FIG. 15 illustrates an exemplary GUI for color story fabrics, FIG. 16 illustrates an exemplary GUI for accessing design kits, FIG. 17 illustrates an exemplary GUI for designing design kits, FIG. 18 illustrates an exemplary GUI for viewing/modifying design kit items, FIG. 19 illustrates an exemplary GUI for adding design kit items, FIG. 20 illustrates an exemplary GUI for viewing fabrics, FIG. 21 illustrates an exemplary GUI for viewing fabric-based products, FIG. 22 illustrates an exemplary GUI for editing fabrics, FIG. 23 illustrates an exemplary GUI for selecting fabric colors, and FIG. 24 illustrates an exemplary GUI for selecting fabric attributes.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable program code. The machine-readable medium may include, but is not limited to, floppy diskettes, optical disks, CD-ROMs, and magneto-optical disks, ROMs, RAMs, EPROMs, EEPROMs, magnetic or optical cards, or other type of media/machine-readable medium suitable for storing electronic program code.

Throughout the foregoing description, for the purposes of explanation, numerous specific details were set forth in order to provide a thorough understanding of the invention. It will be apparent, however, to one skilled in the art that the invention may be practiced without some of these specific details. For example, it will be readily apparent to those of skill in the art that the functional modules and methods described herein may be implemented as software, hardware or any combination thereof. Moreover, although some embodiments of the invention are described herein within the context of a mobile computing environment, the underlying principles of the invention are not limited to a mobile computing implementation. Virtually any type of client or peer data processing devices may be used in some embodiments including, for example, desktop or workstation computers. Accordingly, the scope and spirit of the invention should be judged in terms of the claims which follow.

We claim:

1. A system comprising:
a products database comprising records of home products each having a plurality of attributes associated therewith, and each of the attributes having a weight associated therewith;
a design genome search engine to receive input in the form of an existing product, determine input attributes for the existing product and responsively compare the input attributes with the attributes related to the home products in the products database to determine distances between the input attributes and the attributes related to the home products in the products database; and
the design genome search engine to generate a ranked list of home products from the products database using the determined distances and the weights associated with each of the attributes.

2. The system as in claim 1 wherein to generate the ranked list, the design genome search engine is to generate scores based on the distances between the input attributes and the attributes related to the home products in the products database and further based on each of the weights, wherein the ranked list is ordered based on the scores.

3. The system as in claim 2 wherein the attributes comprise design style, colors, patterns, design scale, design technique, materials, form, visual weight, craftsmanship, finish & trim, fabric content, and/or metal content.

4. The system as in claim 3 wherein each attribute is weighted in accordance with the attribute being capable of identifying comparable and/or compatible home products.

5. The system as in claim 1 further comprising:
a patterns database to store a plurality of design patterns, each of the design patterns comprising a plurality of design elements;
a colors database to store a plurality of color stories, each of the color stories comprising a plurality of colors pre-selected to work together when used on home products; and
a colors system to automatically map each color from a selected color story to a particular design element of a design pattern selected from the patterns database to generate a colored pattern.

6. The system as in claim 5 further comprising:
a product models database to store product models comprising data related to home product specifications; and
a product imaging system communicatively coupled to the product models database and configured to map a particular colored pattern generated by the colors system to a product model selected by a user and to visually display an image showing the colored pattern used on a home product represented by the product model.

7. The system as in claim 6 further comprising:
an imaging file system to store images of the home product represented by the product model with the colored pattern mapped thereon.

8. The system as in claim 7 further comprising:
a voting system to provide a graphical interface to allow designers and users to review images of products with colored patterns mapped thereon and to submit feedback related to the products with the colored patterns, the feedback from multiple designers and users to be combined to form a score.

9. The system as in claim 8 further comprising:
a final products database to store images of products which have received a score above a specified threshold, the final products database being made accessible to the design genome search engine, wherein products are to be stored in the final products database with the plurality of attributes used to perform searches by the design genome search engine.

10. The system as in claim 9 further comprising:
a design kits module to provide an interface for a designer or user to specify one or more design kits, each design kit comprising a plurality of patterns, a color story, one or more solid fabrics and one or more paint colors.

11. The system as in claim 10 wherein the design genome search engine is provided with an indication of a selected design kit, the design genome search engine to perform its search based, at least in part, on the design kit selected.

12. The system as in claim 11 wherein the design genome search engine is to perform its search to identify products with attributes corresponding to the selected design kit.

13. A method comprising:
storing records of home products in a products database, each of the home products having a plurality of attributes associated therewith, and each of the attributes having a weight associated therewith;
receiving input in the form of an existing product;
determining input attributes for the existing product and responsively comparing the input attributes with the attributes related to the home products in the products database to determine distances between the input attributes and the attributes related to the home products in the products database; and
generating a ranked list of home products from the products database using the determined distances and the weights associated with each of the attributes.

14. The method as in claim 13 further comprising generating the ranked list by generating scores based on the distances between the input attributes and the attributes related to the home products in the products database and further based on each of the weights, wherein the ranked list is ordered based on the scores.

15. The method as in claim 12 wherein the attributes comprise design style, colors, patterns, design scale, design technique, materials, form, visual weight, craftsmanship, finish & trim, fabric content, and/or metal content.

16. The method as in claim 15 wherein each attribute is weighted in accordance with the attribute being capable of identifying comparable and/or compatible home products.

17. The method as in claim 13 further comprising:
a patterns database to store a plurality of design patterns, each of the design patterns comprising a plurality of design elements;
a colors database to store a plurality of color stories, each of the color stories comprising a plurality of colors pre-selected to work together when used on home products; and
a colors system to automatically map each color from a selected color story to a particular design element of a design pattern selected from the patterns database to generate a colored pattern.

18. The method as in claim 17 further comprising:
a product models database to store product models comprising data related to home product specifications; and
a product imaging system communicatively coupled to the product models database and configured to map a particular colored pattern generated by the colors system to a product model selected by a user and to visually display an image showing the colored pattern used on a home product represented by the product model.

19. The method as in claim 18 further comprising:
an imaging file system to store images of the home product represented by the product model with the colored pattern mapped thereon.

20. The method as in claim 19 further comprising:
a voting system to provide a graphical interface to allow designers and users to review images of products with colored patterns mapped thereon and to submit feedback related to the products with the colored patterns, the feedback from multiple designers and users to be combined to form a score.

21. The method as in claim 20 further comprising:
a final products database to store images of products which have received a score above a specified threshold, the final products database being made accessible to the design genome search engine, wherein products are to be stored in the final products database with the plurality of attributes used to perform searches by the design genome search engine.

22. The method as in claim 21 further comprising:
a design kits module to provide an interface for a designer or user to specify one or more design kits, each design kit comprising a plurality of patterns, a color story, one or more solid fabrics and one or more paint colors.

23. The method as in claim 22 wherein the design genome search engine is provided with an indication of a selected design kit, the design genome search engine to perform its search based, at least in part, on the design kit selected.

24. The method as in claim 23 wherein the design genome search engine is to perform its search to identify products with attributes corresponding to the selected design kit.
